(19) United States
(12) Patent Application Publication
(10) Pub. No.: US 2023/0136869 A1
(43) Pub. Date: May 4, 2023

(54) DETERMINING COMPONENT AND SERVICE RECOMMENDATIONS DURING AN ELECTRIC CHARGE

(71) Applicant: Caterpillar Inc., Peoria, IL (US)

(72) Inventors: Christian D. RITCHIE, Morton, IL (US); Andrew Blake ROBINSON, Peoria, IL (US); Zhanna MUSLIMOVA, Plainfield, IN (US)

(73) Assignee: Caterpillar Inc., Peoria, IL (US)

(21) Appl. No.: 17/452,932

(22) Filed: Oct. 29, 2021

(51) Int. Cl. G06Q 10/00; G06Q 10/10; H02J 7/00; B60L 53/14; B60L 53/65; B60L 53/30

(52) U.S. Cl. CPC G06Q 10/20; B60L 53/14; B60L 53/65; B60L 53/305; G06Q 10/1095; H02J 7/00032; H02J 7/0047; B60L 53/30; E02F 9/2058

(57) ABSTRACT

A battery charging device may detect a connection, from a first machine, to receive an electrical charge to charge a battery of the first machine. The battery charging device may receive, via the connection, machine information regarding the first machine. The battery charging device may identify, based on the machine information, a second machine associated with the first machine. The battery charging device may determine a first recommendation associated with the first machine and a second recommendation associated with the second machine. The first recommendation may identify at least one of a component or a service recommended for the first machine. The second recommendation may identify at least one of a component or a service recommended for the second machine. The battery charging device may provide the first recommendation and the second recommendation while providing the electrical charge to the first machine.

### TECHNICAL FIELD

The present disclosure relates generally to determining component and service recommendations for machines and, for example, to determining component and service recommendations during a charging operation of a machine.

### BACKGROUND

An operator may use a machine, powered by a battery, to perform one or more tasks. As the operator uses the machine, a power of the battery may be consumed. Accordingly, the battery may need to be recharged using a battery charging device. In some situations, the battery charging device may be provided at a location of a dealer.

In some instances, the operator may desire to determine whether parts (e.g., components) and/or services, for the machine, are being offered at the location of the dealer. In this regard, the operator may use a device of the operator to submit information regarding the machine. In some instances, the information regarding the machine may be inaccurate (e.g., incomplete, misnumbered, among other examples). In other words, the information may not accurately identify the machine. Accordingly, the device may receive information regarding incorrect parts and incorrect services for the machine.

The operator may obtain the incorrect parts for installation on the machine and/or cause the machine to receive the incorrect services. Installing incorrect parts and/or receiving incorrect services in this manner may cause damage to the machine and/or may cause the machine to operate in an unintended manner.

Chinese Patent Application Publication No. 110422081 (the ‘081 publication) discloses an electric automobile charging pile including a shell, a control panel, a charge and discharge port, a charge and discharge electric drive module, a power grid access device, a main control module, a vehicle identification module, and a communication module. The ‘081 publication discloses that the vehicle identification module uses a license plate image identification method.

While the ‘081 publication discloses using a license plate image identification method, the license plate number may inaccurately identify the electric car. Additionally, some electric cars may not be provided with a license plate. Accordingly, the ‘081 publication does not resolve the issues described above related to providing inaccurate information regarding a machine. Furthermore, the ‘081 publication does not consider other electric cars in addition to the electric car identified above. Instead, the ‘081 publication is focused on a single electric car.

The battery charge device of the present disclosure solves one or more of the problems set forth above and/or other problems in the art.

### SUMMARY

In some implementations, a method performed by a battery charging device includes detecting a connection, from a first machine, to receive an electrical charge to charge a battery of the first machine; receiving, via the connection, machine information regarding the first machine; identifying, based on the machine information, a second machine associated with the first machine; determining a first recommendation associated with the first machine and a second recommendation associated with the second machine, wherein the first recommendation identifies at least one of a component recommended for the first machine or a service recommended for the first machine, and wherein the second recommendation identifies at least one of a component recommended for the second machine or a service recommended for the second machine; providing, via the connection, the electrical charge to charge the battery of the first machine; and providing the first recommendation and the second recommendation while providing the electrical charge to the first machine.

In some implementations, a battery charging system includes a charging display device; and a battery charging device configured to: detect a connection, from a first machine, to receive an electrical charge to charge a battery of the first machine; receive, via the connection, machine information regarding the first machine; determine, based on the machine information, a first recommendation associated with the first machine and a second recommendation associated with one or more second machines associated with the first machine, wherein the first recommendation identifies at least one of a first component recommended for the first machine or a first service recommended for the first machine, and wherein the second recommendation identifies at least one of a second component recommended for the one or more second machines or a second service recommended for the one or more second machines; and provide the first recommendation and the second recommendation to the charging display device as part of providing the electrical charge to the first machine.

In some implementations, a battery charging device includes one or more memories; and one or more processors configured to: detect a connection, from a first machine, to receive an electrical charge to charge a battery of the first machine; receive, via the connection, machine information regarding the first machine; determine, based on the machine information, a first recommendation associated with the first machine and a second recommendation associated with one or more second machines associated with the first machine, wherein the first recommendation identifies at least one of a first component recommended for the first machine or a first service recommended for the first machine, and wherein the second recommendation identifies at least one of a second component recommended for the one or more second machines or a second service recommended for the one or more second machines; and provide the first recommendation and the second recommendation as part of providing the electrical charge to the first machine.

### BRIEF DESCRIPTION OF THE DRAWINGS

FIG. 1 is a diagram of an example implementation described herein.

FIG. 2 is a diagram of an example system described herein.

FIG. 3 is a flowchart of an example process associated with determining components and services recommendations for different machines during an electrical charge of a machine.

### DETAILED DESCRIPTION

The present disclosure is directed to a battery charging device that provides recommendations for parts (e.g., components) and/or services regarding a machine during a charging operation of the machine. For example, the battery charging device may detect a connection from the machine to charge a battery of the machine. The battery charging device may receive, from the machine, machine information regarding the machine via the connection. The machine information may include a serial number of the machine, which uniquely and accurately identifies the machine.

Based on the machine information, the battery charging device may accurately identify components and/or services for the machine. Additionally, based on the machine information, the battery charging device may identify other machines owned by an owner of the machine and accurately identify components and/or services for the other machines owned by the owner (of the machine). During the charging operation of the machine, the battery charging device may provide information regarding the components and/or services (for the machine and the other machines) as recommendations.

As used herein, the term “owner” may refer to an entity responsible for multiple machines (e.g., battery-powered machines and/or non-battery-powered machines). For example, the owner may include a person, a company, an individual or a company that leases the machine and/or the other machines, an equipment manager (e.g., a person hired by the company to manage/service the machines), supervisors (e.g., who are in charge of a group of machines), among other examples.

In some instances, the battery charging device may be associated with a kiosk. The kiosk may be configured to dispense a component (of the components identified by the battery charging device). For example, the battery charging device may detect selection of information identifying the component and may cause the kiosk to dispense the component.

In some situations, the battery charging device may be incorporated into the kiosk (or vice versa). Alternatively, the battery charging device may be separate from the kiosk.

The term “machine” may refer to a device that performs an operation associated with an industry such as, for example, mining, construction, farming, transportation, or another type of industry. Moreover, one or more implements may be connected to the machine.

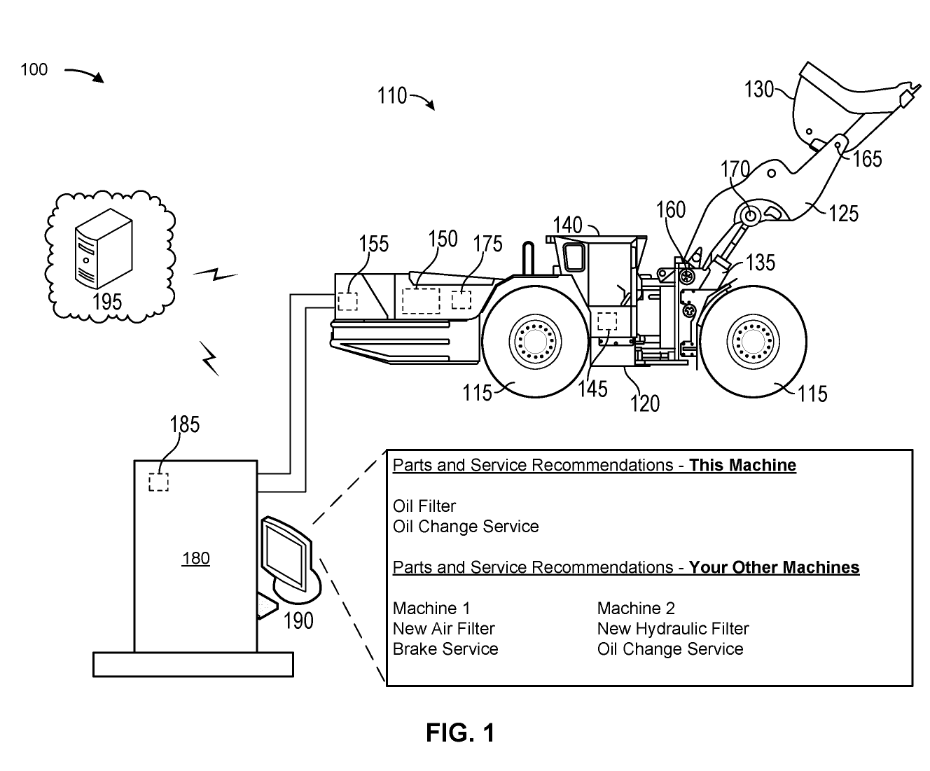

FIG. 1 is a diagram of an example implementation 100 described herein. As shown in FIG. 1, example implementation 100 includes a machine 110, a battery charging device 180, a charging display device 190, and a machine management system 195. As shown in FIG. 1, the machine 110 is embodied as an underground loader (e.g., with an electric drive system). Alternatively, machine 110 may be another type of machine (e.g., with an electric drive system) such as a wheel loader, a dozer, and/or the like.

As shown in FIG. 1, machine 110 includes traction devices 115, a frame 120, a lift arm assembly 125, bucket 130, lift cylinders 135, operator cabin 140, controller 145 (e.g., an electronic control module (ECM)), battery compartments 150, charge ports 155, frame pivot point 160, bucket pivot point 165, lift pivot point 170, and a wireless communication component 175.

Controller 145 may include one or more memories and one or more processors. The one or more memories may store information and/or instructions for use by one or more processors to perform one or more functions, as described below. In some instances, controller 145 may include a programmable logic controller (PLC).

Battery compartments 150 (individually referred to as “battery compartment 150” and collectively referred to as “battery compartments 150”) may include enclosures (e.g., boxes) that include a plurality of groups of batteries, a plurality of disconnect components, and a plurality of battery contactors. A battery compartment 150 may include a portion of the plurality of groups of batteries, a portion of the plurality of disconnect components connected to the plurality of groups of batteries, and a portion of the plurality of contactors (hereinafter referred to “battery contactors”) connected to the plurality of groups of batteries.

Charge ports 155 (referred to as “charge ports 155” collectively and referred to “charge port 155” individually) may be configured to receive power, from a power source (e.g., via a connector of the power source), to charge internal power sources of machine 110 (e.g., the plurality of groups of batteries of battery compartment 150). The power source may include battery charging device 180, batteries, a generator set (e.g., an electrical generator set), among other examples.

Charge ports 155 may be connected to machine 110 via a set of contactors (hereinafter referred to as “charge port contactors”). In some examples, the charge port contactors may include a positive contactor (e.g., a contactor to be connected to a positive terminal of a battery) and a negative contactor (e.g., a contactor to be connected to a negative terminal of the battery). In some implementations, machine 110 may include a single charge port 155. Alternatively, machine 110 may include two or more charge ports 155.

A charge port 155 may include a plurality of high voltage (HV) pins and a plurality of low voltage (LV) pins. In some examples, the plurality of high voltage (HV) pins (e.g., of a charge port 155) may include one or more ground pins, one or more positive pins (e.g., one or more DC bus positive pins), and/or one or more negative pins (e.g., one or more DC bus negative pins).

The plurality of LV pins (e.g., of a charge port 155) may include one or more controller area network (CAN) pins (e.g., to enable CAN communications via the connector of the power source), one or more ground pins (e.g., a pin to monitor ground fault, a pin for ground connection, and/or the like), and/or a wake up pin (e.g., to enable machine 110 to transition from an off state to an on state when the charge port 155 is connected to a power source).

In some instances, controller 145 may cause machine information, regarding machine 100, to be provided to battery charging device 180 via the one or more CAN pins. The machine information may include information identifying a make of machine 100, information identifying a model number of machine 100, information identifying a serial number of machine 100, and/or machine owner information identifying an owner of machine 100, among other information that may uniquely identify machine 100. The machine information may be stored in one or more memories associated with controller 145.

Wireless communication component 175 may include one or more devices that are capable of communicating with one or more other machines and/or one or more devices (e.g., machine management system 195), as described herein. Wireless communication component 175 may include a transceiver, a separate transmitter and receiver, an antenna, and/or the like. Wireless communication component 175 may communicate with the one or more machines using a short-range wireless communication protocol such as, for example, BLUETOOTH® Low-Energy, BLUETOOTH®, Wi-Fi, near-field communication (NFC), Z-Wave, ZigBee, or Institute of Electrical and Electronics Engineers (IEEE) 802.154, among other examples.

Additionally, or alternatively, wireless communication component 175 may communicate with the one or more other machines and/or the one or more devices via a network that includes one or more wired and/or wireless networks, such as, for example, a wireless local area network (LAN), a cellular network (e.g., a long-term evolution (LTE) network, a code division multiple access (CDMA) network, a 3G network, a 4G network, a 5G network, or another type of cellular network), a public land mobile network (PLMN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

In some instances, controller 145 may cause wireless communication component 175 to provide diagnostics information regarding machine 110 to machine management system 195. The diagnostics information may include wear information indicating an amount of wear of one or more components of machine 110, replacement information indicating a date and/or a time when the one or more components were replaced, machine work time information indicating an amount of time that machine 110 spent performing one or more tasks, task information regarding the one or more tasks performed by machine 110, last service information regarding a last service that was performed on machine 110, and/or upcoming service information regarding an upcoming service for machine 110, among other examples.

The last service information may include a date and a time that the last service was performed, information identifying a type of the last service, among other examples. The type of the last service may include a routine maintenance (e.g., an oil change service, a brake service, among other examples), a recommended maintenance (e.g., a maintenance recommended based on an amount of hours during which machine 110 was used, based on an amount of miles of machine 110, among other examples), a requested maintenance (e.g., a service requested by the owner of machine 110 and/or an operator of machine 110), among other examples.

Battery charging device 180 may include one or more devices capable of providing electrical power for charging a battery of machine 110 (e.g., for providing an electric charge to charge the battery of machine 110). For example, battery charging device 180 may include the one or more devices capable of providing Alternating Current (AC) power and/or Direct Current (DC) power to charge the battery.

Additionally, or alternatively, the one or more devices may be capable of receiving, generating, storing, processing, providing, and/or routing information associated with recommendations regarding components and/or services for machine 110 and for one or more additional machines (associated with machine 110) while (or as part of) providing the electric charge to charge the battery of machine 110, as described herein. For example, the recommendations may be provided before providing the electric charge, after providing the electric charge, and/or during providing the electric charge. As shown in FIG. 1, battery charging device 180 may include a wireless communication component 185. Wireless communication component 185 may be similar to wireless communication component 175 described above.

Charging display device 190 may include one or more devices capable of providing (e.g., for display) the recommendations while battery charging device 180 is providing the electric charge to charge the battery of machine 110. As shown in FIG. 1, the recommendations (for machine 110) may include a recommendation to purchase a new air filter and a recommendation to receive an oil change service. As further shown in FIG. 1, the recommendations (for another machine) may include a recommendation to purchase a new air filter and a recommendation to receive a brake service. In some implementations, charging display device 190 may be included in battery charging device 180. Alternatively, charging display device 190 may be separate from battery charging device 180.

Machine management system 195 may include one or more devices capable of receiving, generating, storing, processing, providing, and/or routing information associated with recommendations regarding components and/or services for machine 110 and for one or more other machines. For example, machine management system 195 may receive (e.g., from battery charging device 180) a request for information regarding the recommendations and may provide the information regarding the recommendations, as explained below.

In some implementations, machine management system 195 may store (e.g., in one or more memories of machine management system 195) information regarding different machines and information regarding different owners of the different machines. For example, machine management system 195 may store the machine owner information (of the owner of machine 110) in association with the machine information of machine 110 and the diagnostics information of machine 110. In some implementations, machine management system 195 may include one or more secure servers that are implemented as a cloud computing environment and that store the machine owner information, the machine information, and the diagnostics information. In some examples, machine management system 195 may provide a portion of the machine owner information and the machine information to charging display device 190, as described herein. In other words, the machine owner information and the machine information may only display the portion of the machine owner information and the machine information (e.g., without storing the portion of the machine owner information and the machine information). Machine management system 195 may receive the diagnostics information from machine 110 and may store the diagnostics information in association with the machine information and the machine owner information.

In some implementations, machine management system 195 may receive a portion of the diagnostics information from a service device different than machine 110. For example, machine management system 195 may receive the last service information from the service device. For instance, the service device may provide information regarding types of repairs and types of maintenance that were performed during the last service. The service device may include a device provided at a location where the last service was performed, a back office system, a device associated with the owner of machine 110, among other examples.

Machine management system 195 may receive the diagnostics information periodically (e.g., every hour, every two hours, at the end of a work shift, among other examples). Additionally, or alternatively, machine management system 195 may receive the diagnostics information based on a trigger (e.g., based on machine management system 195 providing a request to machine 110 and/or to the service device). Machine management system 195 may store additional machine information regarding one or more additional machines (owned by the owner of machine 110) in association with additional diagnostics information regarding the one or more additional machines and the machine owner information. As an example, machine 110 and the one or more additional machines may be part of a fleet of machines.

The additional machine information regarding the one or more additional machines may include information similar to information included in the machine information regarding machine 110. The additional diagnostics information regarding the one or more additional machines may include information similar to information included in the diagnostics information regarding machine 110. Machine management system 195 may receive the additional diagnostics information and may store the additional diagnostics information in a manner similar to the manner described above with respect to the diagnostics information.

The number and arrangement of devices and networks shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the example implementation 100 may perform one or more functions described as being performed by another set of devices of the example implementation 100.

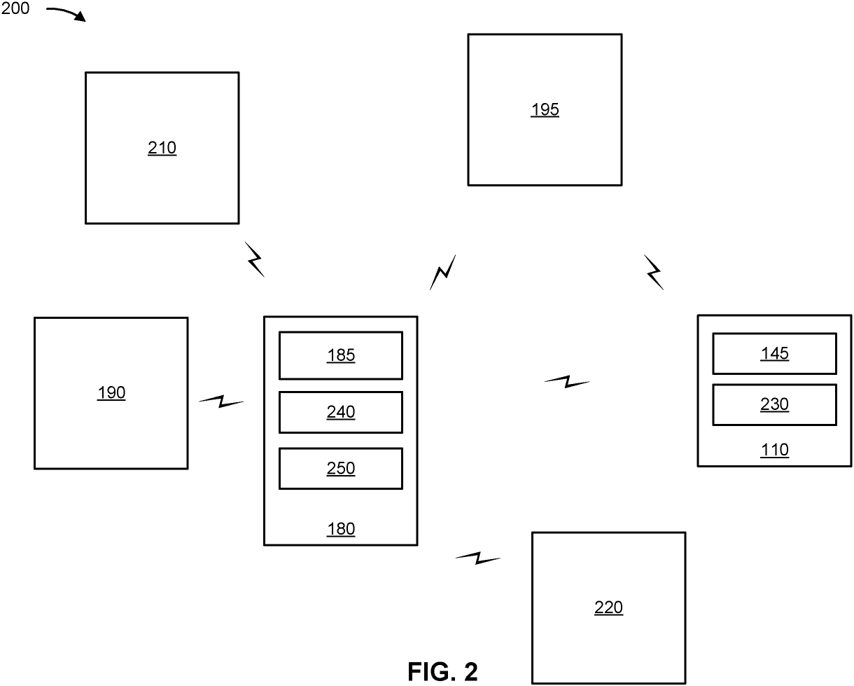

FIG. 2 is a diagram of an example system 200 described herein. As shown in FIG. 2, the example system 200 includes machine 110, battery charging device 180, charging display device 190, machine management system 195, a user device 210, and an accessory device 220. Machine 110, battery charging device 180, charging display device 190, and machine management system 195 have been described above in connection with FIG. 1 above. As shown in FIG. 2, machine 110 may include wireless communication component 175 and a machine display device 230. Machine display device 230 may include one or more devices capable of providing recommendations regarding components and/or services for machine 110 and the one or more additional machines, as described herein.

As shown in FIG. 2, battery charging device 180 may include wireless communication component 185, a memory 240, and a processor 250. Memory 240 includes a random-access memory (RAM), a read only memory (ROM), and/or another type of dynamic or static storage device (e.g., a flash memory, a magnetic memory, and/or an optical memory) that stores information and/or instructions for use by processor 250 to perform a function.

Processor 250 includes a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. Processor 250 is implemented in hardware, firmware, and/or a combination of hardware and software. Processor 250 may be capable of being programmed to perform a function.

User device 210 includes one or more devices capable of receiving, generating, storing, processing, and/or providing information associated with recommendations regarding components and/or services for machine 110 and the one or more additional machines, as described herein. User device 210 may include a communication device and computing device. For example, user device 210 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

Accessory device 220 includes one or more devices capable of receiving, generating, storing, processing, and/or providing information identifying the operator of machine 110. As an example, accessory device 220 may include a key fob device. In some situations, the information identifying the operator may indicated that the operator is the owner of machine 110.

In the example that follows, machine 110 may be connected to battery charging device 180 to receive an electrical charge to charge a battery of machine 110. For example, a charge port 155 of machine 110 may be connected to a connector of battery charging device 180. Battery charging device 180 may detect a connection from machine 110 to receive the electrical charge based on the charge port 155 being connected to the connector of battery charging device 180. In some examples, based on detecting the connection, battery charging device 180 may perform one or more handshake procedures with machine 110 and establish a communication session with machine 110 based on the one or more handshake procedures.

In some instances, during the communication session, battery charging device 180 may provide (to machine 110) charging capacity information regarding a charging capacity of battery charging device 180 and receive (from machine 110) charging requirement information regarding a charging requirement of battery charging device 180. Based on providing the charging capacity information and receiving the charging requirement information, battery charging device 180 may initiate a charging operation to charge the battery of machine 110.

During the communication session, battery charging device 180 may receive the machine information from machine 110. For example, controller 145 may cause the machine information, regarding machine 110, to be provided to battery charging device 180 via one or more CAN pins of charge port 155. For instance, a data link may be established between battery charging device 180 and machine 110 via the one or more CAN pins. Controller 145 may obtain the machine information from a CAN bus (e.g., associated with the one or more CAN pins) and may cause the machine information to be provided, to battery charging device 180, via the data link.

In some examples, battery charging device 180 may receive the machine information and generate a request for the diagnostics information regarding machine 110. Battery charging device 180 may provide the request to machine management system 195, and machine management system 195 may search the one or more memories of machine management system 195 using the machine information. Machine management system 195 may identify the diagnostics information regarding machine 110 (e.g., associated with the machine information) and provide the diagnostics information to battery charging device 180.

In some examples, battery charging device 180 may obtain the diagnostics information regarding machine 110 and the diagnostics information regarding the one or more additional machines by providing multiple requests to machine management system 195. For example, battery charging device 180 may receive the machine information and generate a first request for the machine owner information identifying the owner of machine 110. The first request may include the machine information.

Battery charging device 180 may provide the first request to machine management system 195. Machine management system 195 may receive the first request and may search the one or more memories of machine management system 195, using the machine information, to identify the machine owner information (e.g., associated with the machine information). Machine management system 195 may identify the machine owner information and provide the machine owner information to battery charging device 180.

Battery charging device 180 may receive the machine owner information and generate a second request for diagnostic information of all or a subset of machines owned by the owner of machine 110. For example, the second request may be generated to obtain diagnostic information of all battery-powered machines, all machines within a distance threshold of machine 110, all machines of a certain type (e.g., hauling machines, loading machines, pipelayer machines, among other examples). The second request may include the machine owner information. Machine management system 195 may receive the second request and may search the one or more memories of machine management system 195, using the machine owner information, to identify all machines owned by the owner of machine 110 (e.g., machine 110 and the one or more additional machines). Machine management system 195 may identify information regarding the machines owned by the owner of machine 110. The information regarding the machines may include diagnostics information of the machines (e.g., the diagnostics information regarding machine 110 and the diagnostics information regarding the one or more additional machines). Machine management system 195 may provide the information regarding the machines to battery charging device 180.

Battery charging device 180 may analyze the information regarding the machines and determine recommendations regarding the machines based on analyzing the information regarding the machines. As an example, battery charging device 180 may analyze the diagnostics information regarding machine 110. For instance, battery charging device 180 may determine whether a first component of machine 110 is to be repaired or replaced based on the wear information included in the diagnostics information.

For example, battery charging device 180 may compare an amount of wear of the first component (identified by the wear information) to a first wear threshold associated with repairing components. If battery charging device 180 determines that the amount of wear satisfies the first threshold, machine management system 195 may determine that the first component is to be repaired. Accordingly, battery charging device 180 may determine a recommendation to repair the first component.

As another example, battery charging device 180 may compare the amount of wear of the first component to a second wear threshold associated with replacing components. If battery charging device 180 determines that the amount of wear satisfies the second threshold, battery charging device 180 may determine that the first component is to be replaced. Accordingly, battery charging device 180 may determine a recommendation to replace the first component. Information regarding the first wear threshold, the second wear threshold, and other thresholds described herein may be received from machine management system 195 and/or from the service device.

Battery charging device 180 may determine whether a second component of machine 110 is to be replaced based on the replacement information indicating a date and/or a time when the second component was installed on machine 110. For example, battery charging device 180 may determine a period of time elapsed since the second component was installed on machine 110. If battery charging device 180 determines that the period of time satisfies a time threshold, battery charging device 180 may determine that the second component is to be replaced. Accordingly, battery charging device 180 may determine a recommendation to replace the second component.

Battery charging device 180 may determine whether machine 110 is to be serviced based on the machine work time information and the task information. The machine work time may indicate the amount of time that machine 110 spent performing the one or more tasks. The task information may identify a type of the one or more tasks and may indicate different amounts of wear caused by the one or more tasks (e.g., based on different amounts of time spent performing the one or more tasks).

In this regard, based on the amount of time that machine 110 spent performing the one or more tasks, battery charging device 180 may determine an amount of wear caused by machine 110 performing the one or more tasks. If battery charging device 180 determines that the amount of wear satisfies a machine wear threshold, battery charging device 180 may determine a recommendation indicating that machine 110 is to be serviced.

Battery charging device 180 may determine whether machine 110 is to be serviced based on the last service information. For example, battery charging device 180 may determine an amount of time elapsed since the last service. If battery charging device 180 determines that the amount of time satisfies a service time threshold, battery charging device 180 may determine a recommendation indicating that machine 110 is to be serviced.

Battery charging device 180 may determine whether machine 110 is to be serviced based on the upcoming service information. The upcoming service information may include information identifying a date and/or a time for the upcoming service. For example, battery charging device 180 may determine whether a current date and/or time is within a date and time threshold of the date and/or the time for the upcoming service. If battery charging device 180 determines that the current date and/or the time is within the date and time threshold of the date and/or the time for the upcoming service, battery charging device 180 may determine a recommendation indicating that machine 110 is to be scheduled for the upcoming service.

Battery charging device 180 may determine recommendations for the one or more additional machines in a manner similar to the manner described above in connection with determining the recommendations for machine 110. In some situations, the information regarding the machines may include recommendations regarding one or more components and/or one or more services for the machines. In this regard, the recommendations may be determined by machine management system 195. The one or more components may include components that are to be replaced to improve a performance of machine 110.

Battery charging device 180 may provide the recommendations determined above for machine 110 and for the one or more additional machines. For example, battery charging device 180 may provide the recommendations while providing the electrical charge to machine 110 (e.g., via the connection). In some examples, battery charging device 180 may provide the recommendations to charging display device 190. Additionally, or alternatively, battery charging device 180 may provide the recommendations to machine display device 230. Additionally, or alternatively, battery charging device 180 may provide the recommendations to user device 210.

In some situations, battery charging device 180 may determine whether a particular component is available prior to providing a recommendation regarding the particular component. For example, prior to providing the recommendation regarding the particular component, battery charging device 180 may determine whether the particular component is available to be provided via the kiosk, is available a location of the dealer (e.g., associated with battery charging device 180), is available to be shipped, among other examples.

In some examples, when providing the recommendations, battery charging device 180 may detect, via a short-range wireless communication protocol, accessory device 220. For example, battery charging device 180 may receive (e.g., from accessory device 220) information identifying the operator and determine whether accessory device 220 is associated with the owner of machine 110.

If battery charging device 180 determines that accessory device 220 is associated with the owner, battery charging device 180 may provide the recommendations to charging display device 190 associated with the battery charging device. If battery charging device 180 determines that accessory device 220 is not associated with the owner, battery charging device 180 may provide the recommendation to user device 210. User device 210 may be a user device of the operator.

In some situations, battery charging device 180 may receive feedback associated with a recommendation and perform an action based on the feedback. For example, battery charging device 180 may detect that information regarding the recommendation has been selected via charging display device 190, via user device 210, among other examples. Based on receiving the feedback, battery charging device 180 may cause a component (identified by the recommendation) to be provided to a location associated with machine 110.

The location associated with machine 110 may include a current location of machine 110, a location associated with the owner, among other examples. As an example, battery charging device 180 may cause the kiosk to dispense the component. Additionally, or alternatively, to causing the component to be provided via the kiosk, battery charging device 180 may cause a service (identified by the recommendation) to be scheduled for machine 110.

The number and arrangement of devices and networks shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example system 200 may perform one or more functions described as being performed by another set of devices of the example implementation 100.

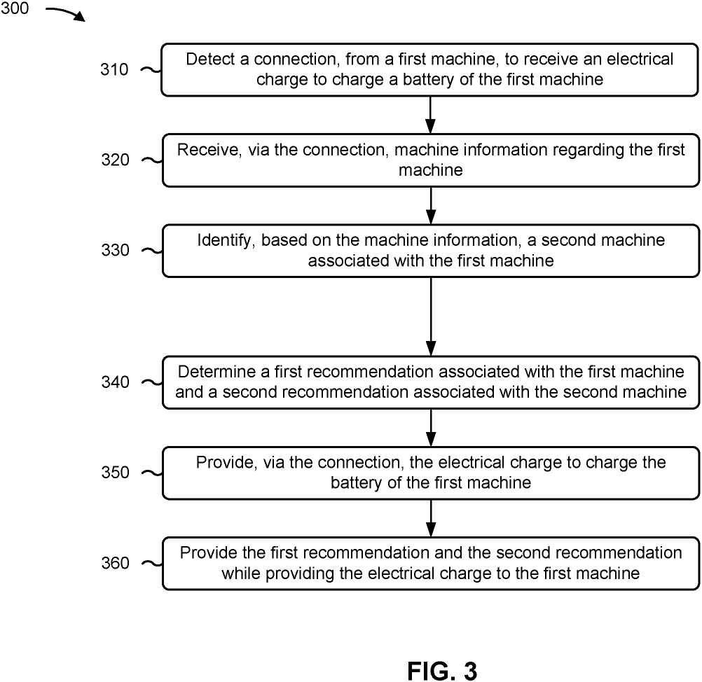

FIG. 3 is a flowchart of an example process 300 associated with determining component and service recommendations during an electrical charge. In some implementations, one or more process blocks of FIG. 3 may be performed by a battery charging device (e.g., battery charging device 180). In some implementations, one or more process blocks of FIG. 3 may be performed by another device or a group of devices separate from or including the battery charging device, such as a machine (e.g., machine 110), a machine management system (e.g., machine management system 195), a charging display device (e.g., charging display device 190), and/or a user device (e.g., user device 210).

As shown in FIG. 3, process 300 may include detecting a connection, from a first machine, to receive an electrical charge to charge a battery of the first machine (block 310). For example, the battery charging device may detect a connection, from a first machine, to receive an electrical charge to charge a battery of the first machine, as described above.

As further shown in FIG. 3, process 300 may include receiving, via the connection, machine information regarding the first machine (block 320). For example, the battery charging device may receive, via the connection, machine information regarding the first machine, as described above. In some implementations, receiving the machine information comprises receiving at least one of information identifying a make of the first machine, information identifying a model number of the first machine, or information identifying a serial number of the first machine.

As further shown in FIG. 3, process 300 may include identifying, based on the machine information, a second machine associated with the first machine (block 330). For example, the battery charging device may identify, based on the machine information, a second machine associated with the first machine, as described above. In some implementations, identifying the second machine comprises determining, based on the machine information, machine owner information identifying an owner of the first machine, and identifying, based on the machine owner information, one or more additional machines owned by the owner of the first machine, wherein the one or more additional machines include the second machine. The first machine may be associated with an owner or organization which may own the second machine.

As further shown in FIG. 3, process 300 may include determining a first recommendation associated with the first machine and a second recommendation associated with the second machine, wherein the first recommendation identifies at least one of a component recommended for the first machine or a service recommended for the first machine, and wherein the second recommendation identifies at least one of a component recommended for the second machine or a service recommended for the second machine (block 340). For example, the battery charging device may determine a first recommendation associated with the first machine and a second recommendation associated with the second machine, wherein the first recommendation identifies at least one of a component recommended for the first machine or a service recommended for the first machine, and wherein the second recommendation identifies at least one of a component recommended for the second machine or a service recommended for the second machine, as described above. In some implementations, the first recommendation identifies at least one of a component recommended for the first machine or a service recommended for the first machine. In some implementations, the second recommendation identifies at least one of a component recommended for the second machine or a service recommended for the second machine.

As further shown in FIG. 3, process 300 may include providing, via the connection, the electrical charge to charge the battery of the first machine (block 350). For example, the battery charging device may provide, via the connection, the electrical charge to charge the battery of the first machine, as described above.

As further shown in FIG. 3, process 300 may include providing the first recommendation and the second recommendation while providing the electrical charge to the first machine (block 360). For example, the battery charging device may provide the first recommendation and the second recommendation while providing the electrical charge to the first machine, as described above.

In some implementations, providing the first recommendation and the second recommendation comprises at least one of providing the first recommendation and the second recommendation to a machine display device associated with the battery charging device, or providing the first recommendation and the second recommendation to a machine display device of the first machine.

In some implementations, providing the first recommendation and the second recommendation comprises providing the first recommendation and the second recommendation to a device of the owner.

In some examples, process 300 may include receiving feedback associated with the first recommendation; and based on receiving the feedback, at least one of: causing the component recommended for the first machine to be provided to a location associated with the first machine; or causing the service recommended for the first machine to be scheduled for the first machine. In some examples, receiving the feedback comprises: receiving the feedback from a display device associated with the battery charging device; or receiving the feedback from a display device of the first machine.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

### INDUSTRIAL APPLICABILITY

The present disclosure is directed to a battery charging device that provides recommendations for parts (e.g., components) and/or services regarding a machine during a charging operation of the machine. For example, the battery charging device may detect a connection from the machine to charge a battery of the machine. The battery charging device may receive, from the machine, machine information regarding the machine via the connection. The machine information may include a serial number of the machine, which uniquely and accurately identifies the machine.

Based on the machine information, the battery charging device may accurately identify components and/or services for the machine. Additionally, based on the machine information, the battery charging device may identify other machines owned by an owner of the machine and accurately identify components and/or services for the other machines owned by an owner of the machine. During the charging operation of the machine, the battery charging device may provide information regarding the parts and/or services (for the machine and the other machines) as recommendations.

As explained above, information that inaccurately identifies the machine may cause incorrect components and/or incorrect services to be identified for the machine. An operator may obtain the incorrect parts for installation on the machine and/or cause the machine to receive the incorrect services. Installing incorrect components and/or receiving incorrect services in this manner may cause damage to the machine and/or may cause the machine to operate in an unintended manner.

The battery charging device of the present disclosure accurately identifies components and/or services for the machine. By accurately identifying the components and/or the services as described herein, the battery charging service may prevent installation of incorrect components on the machine and/or prevent the machine from receiving incorrect services. By preventing installation of incorrect parts and/or preventing the machine from receiving incorrect services, the battery charging service may prevent damage to the machine and/or prevent the machine from operating in an unintended manner.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method performed by a battery charging device, the method comprising:
detecting a connection, from a first machine, to receive an electrical charge to charge a battery of the first machine;
receiving, via the connection, machine information regarding the first machine;
identifying, based on the machine information, a second machine associated with the first machine;
determining a first recommendation associated with the first machine and a second recommendation associated with the second machine,
wherein the first recommendation identifies at least one of a component recommended for the first machine or a service recommended for the first machine, and
wherein the second recommendation identifies at least one of a component recommended for the second machine or a service recommended for the second machine;
providing, via the connection, the electrical charge to charge the battery of the first machine; and
providing the first recommendation and the second recommendation while providing the electrical charge to the first machine.

2. The method of claim 1, wherein providing the first recommendation and the second recommendation comprises at least one of:
providing the first recommendation and the second recommendation to a charging display device associated with the battery charging device; or
providing the first recommendation and the second recommendation to a machine display device of the first machine.

3. The method of claim 1, wherein receiving the machine information comprises:
receiving at least one of information identifying a make of the first machine, information identifying a model number of the first machine, or information identifying a serial number of the first machine.

4. The method of claim 1, wherein identifying the second machine comprises:
determining, based on the machine information, machine owner information identifying an owner of the first machine; and
identifying, based on the machine owner information, one or more additional machines owned by the owner of the first machine,
wherein the one or more additional machines include the second machine.

5. The method of claim 4, wherein providing the first recommendation and the second recommendation comprises:
providing the first recommendation and the second recommendation to a device of the owner.

6. The method of claim 1, further comprising:
receiving feedback associated with the first recommendation; and
based on receiving the feedback, at least one of:
causing the component recommended for the first machine to be provided to a location associated with the first machine; or
causing the service recommended for the first machine to be scheduled for the first machine.

7. The method of claim 6, wherein receiving the feedback comprises:
receiving the feedback from a charging display device associated with the battery charging device; or
receiving the feedback from a machine display device of the first machine.

8. A battery charging system, comprising:
a charging display device; and
a battery charging device configured to:
detect a connection, from a first machine, to receive an electrical charge to charge a battery of the first machine;
receive, via the connection, machine information regarding the first machine;
determine, based on the machine information, a first recommendation associated with the first machine and a second recommendation associated with one or more second machines associated with the first machine,
wherein the first recommendation identifies at least one of a first component recommended for the first machine or a first service recommended for the first machine, and
wherein the second recommendation identifies at least one of a second component recommended for the one or more second machines or a second service recommended for the one or more second machines; and provide the first recommendation and the second recommendation to the charging display device as part of providing the electrical charge to the first machine.

9. The battery charging system of claim 8, wherein, to determine the first recommendation and the second recommendation, the battery charging device is configured to:
obtain, based on the machine information and from a device located remotely from the first machine, diagnostics information regarding the first machine; and
determine the first recommendation based on the diagnostics information.

10. The battery charging system of claim 8, wherein the battery charging device is further configured to:
provide, to a device located remotely from the first machine and the battery charging device, a first request for machine owner information identifying an owner of the first machine,
wherein the first request includes the machine information;
receive, based on the first request, the machine owner information;
provide, to the device, a second request for additional machine information regarding one or more additional machines owned by the owner of the first machine,
wherein the second request includes the machine owner information; and
receive, based on the second request, the information regarding the one or more additional machines owned by the owner of the first machine,
wherein the one or more additional machines include the second machine.

11. The battery charging system of claim 10, wherein the information regarding the one or more additional machines includes additional diagnostics information regarding the second machine; and
wherein, to determine the first recommendation and the second recommendation, the battery charging device is configured to:
determine the second recommendation based on the additional diagnostics information.

12. The battery charging system of claim 8, wherein, to receive the machine information, the battery charging device is configured to:
receive at least one of information identifying a make of the first machine, information identifying a model number of the first machine, information identifying a serial number of the first machine, or machine owner information identifying an owner of the first machine.

13. The battery charging system of claim 8, wherein the battery charging device is further configured to at least one of:
provide the first recommendation and the second recommendation to a machine display device of the first machine; or
provide the first recommendation and the second recommendation to a user device of an owner of the first machine.

14. The battery charging system of claim 8, wherein the battery charging device is further configured to:
receive feedback associated with the second recommendation; and
based on receiving the feedback, at least one of:
causing the second component to be provided to a location associated with the one or more second machines; or
causing the second service to be scheduled for the one or more second machines.

15. A battery charging device, comprising:
one or more memories; and
one or more processors configured to:
detect a connection, from a first machine, to receive an electrical charge to charge a battery of the first machine;
receive, via the connection, machine information regarding the first machine;
determine, based on the machine information, a first recommendation associated with the first machine and a second recommendation associated with one or more second machines associated with the first machine,
wherein the first recommendation identifies at least one of a first component recommended for the first machine or a first service recommended for the first machine, and
wherein the second recommendation identifies at least one of a second component recommended for the one or more second machines or a second service recommended for the one or more second machines; and
provide the first recommendation and the second recommendation while as part of providing the electrical charge to the first machine.

16. The battery charging device of claim 15, wherein, to provide the first recommendation and the second recommendation, the one or more processors are configured to:
detect, via a short-range wireless communication protocol, an accessory device associated with the first machine;
determine whether the accessory device is associated with an owner of the first machine or an operator of the first machine;
provide the first recommendation and the second recommendation to a charging display device associated with the battery charging device if the accessory device is associated with the owner of the first machine; and
provide the first recommendation and the second recommendation to a user device of the operator if the accessory device is associated with the operator.

17. The battery charging device of claim 15, wherein, to receive the machine information, the one or more processors are configured to:
receive at least one of information identifying a make of the first machine, information identifying a model number of the first machine, or information identifying a serial number of the first machine.

18. The battery charging device of claim 15, wherein, to provide the first recommendation and the second recommendation, the one or more processors are configured to at least one of:
provide the first recommendation and the second recommendation to a charging display device associated with the battery charging device; or
provide the first recommendation and the second recommendation to a machine display device of the first machine.

19. The battery charging device of claim 15, wherein the one or more processors are further configured to:
provide, to a device located remotely from the first machine and the battery charging device, a first request for machine owner information identifying an owner of the first machine,
wherein the first request includes the machine information;
receive, based on the first request, the machine owner information;
provide, to the device, a second request for information regarding one or more additional machines owned by the owner of the first machine,
wherein the second request includes the machine owner information; and receive, based on the second request, information regarding the one or more additional machines owned by the owner of the first machine,
wherein the one or more additional machines include the second machine.

20. The battery charging device of claim 15, wherein the one or more processors are further configured to:
receive feedback associated with the second recommendation; and
based on receiving the feedback, at least one of:
cause the second component to be provided to a location associated with the one or more second machines; or
cause the second service to be scheduled for the one or more second machines.
